(19) United States
(12) Patent Application Publication
(10) Pub. No.: US 2026/0349327 A1
(43) Pub. Date: Nov. 5, 2026

(54) Film Processing Apparatus

(71) Applicant: Oliver Alter Duhigg, Santa Cruz, CA (US)

(72) Inventor: Oliver Alter Duhigg, Santa Cruz, CA (US)

(21) Appl. No.: 19/197,158

(22) Filed: May 2, 2025

(51) Int. Cl. G03D 13/00; G03D 5/06

(52) U.S. Cl. CPC G03D 13/006; G03D 5/06; G03D 13/007; G03D 2203/0683

(57) ABSTRACT

A bench-top device for automated photo-sensitive film development utilizes one or more chemical pumps to deliver development chemicals from separate chemical reservoirs to a development tank. A magnetic motor provides controlled agitation by spinning the film holder within the development tank, ensuring uniform development. This apparatus provides a compact and efficient solution for small-scale, batch film processing.

### BACKGROUND

### Field of the Invention

This disclosure relates to film processing; more specifically, this disclosure relates to an apparatus which partially automates the process of developing photographic film.

### Description of the Related Art

Photographic film processing generally involves a series of steps which require accurate control of temperature, time, and chemical agitation. Common small-scale film processing methods usually rely on darkroom environments and manual performance of development tasks, such as the manual exchange of development chemistry between various tanks, or hand-agitation of in-use chemistry. This process can be time-consuming as well as prone to any manner of adverse outcomes due to human error, and demands a high degree of focus and precision from the user.

Film processing tanks are containers which hold film reels with the purpose of allowing them to be submerged in various development chemicals while protecting them from exposure to external light. Agitation of the development tank, and subsequently the chemistry within it, is for the most part required to ensure even development of the film. Manual agitation methods are susceptible to variations in agitation speed and consistency, leading to uneven development and the potential for artifacts or abnormalities on the final image.

Accurately controlling the temperature of the development chemistry is crucial for achieving consistent results. Common methods involve immersing the development tank in a water bath to maintain the desired temperature through thermal equilibrium. However, this method may require continuous monitoring and temperature adjustment, which can be challenging and imprecise. The use of thermal conduction through the development tank may also significantly prolong the heating process in implementations of this method, and inhibit the stable maintenance of target temperatures.

Automated film processors have been developed to address some of these challenges. However, many existing automated systems are large, complex, expensive, and designed for high-volume professional applications. These systems often lack the flexibility and affordability required for individual photographers or smaller film development labs. Furthermore, the aforementioned systems are, in many cases, not designed in such a way that a user could perform the maintenance periodically required for their upkeep, which could necessitate the assistance of a repair technician to achieve basic maintenance, further inhibiting the accessibility of these systems.

Moreover, many automated film development systems are built on ‘closed-source’ design principles, reducing the user's ability to adapt the system's hardware or software to achieve specific parameters or artistic effects. This restrictive mode of design can limit the user's creative control and their ability to fine-tune key development variables.

There remains a need for a film processing device that offers a balance between automation and manual control, providing users with improved consistency and convenience while retaining the ability to customize the development process. Such a device should be affordable, easy to use, capable of delivering high-quality results, and built on open-source design principles so as to be easily manufacturable and repairable.

The present invention addresses these shortcomings by providing an automated film developing device that improves film development consistency, offers greater control over the film development process, and is accessible to consumers outside of professional and industry settings.

### SUMMARY

A bench-top device for semi-automated photographic film development utilizes a multi-channel pump system to deliver development chemistry from separate chemical reservoirs to a detachable development tank. A magnetic motor provides controlled agitation by spinning the film holder within the development tank, ensuring uniform development. This apparatus provides a compact and efficient solution for small-scale, batch film processing.

### BRIEF DESCRIPTION OF THE DRAWINGS

Other features, combinations, and embodiments will be appreciated by one having the ordinary level of skill in the art of film processing and accessories upon a thorough review of the following details and descriptions, particularly when reviewed in conjunction with the drawings, wherein:

FIG. 1 shows a process flow diagram of a film processing apparatus in accordance with a first illustrated embodiment;

FIG. 2 shows a circuit diagram of the film processing apparatus in accordance with a first illustrated embodiment;

FIG. 3 shows a process flow diagram of a film processing apparatus in accordance with a second illustrated embodiment;

FIG. 4 shows a user interface for the film processing apparatus in accordance with a first illustrated embodiment;

FIG. 5 shows a development tank system for the film processing apparatus in accordance with a third illustrated embodiment; and

FIG. 6 shows part of the film processing apparatus in accordance with a first illustrated embodiment.

### DETAILED DESCRIPTION

For purposes of explanation and not limitation, details and descriptions of certain preferred embodiments are provided such that a skilled user may make and use the invention. These details and descriptions are representative only of certain preferred embodiments, however, a myriad of other embodiments which will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

For purposes herein, reference numbers are provided in the drawings for illustrating certain features of embodiments. Where distinct figures of the drawings utilize a shared reference number, it can be appreciated that the feature corresponding to the shared reference number is the same or similar, perhaps observed from a different view, or observed with respect to a different embodiment deploying the same or similar feature.

For purposes herein, the term “coupled” means that the coupled components, articles, or systems are separable from each other.

The term “attached” means that the attached components, articles, or systems are not separable from each other.

The term “integrated” means that the integrated components, articles, or systems refer to features which together form a continuous body.

The term “joined” may be taken to mean “coupled,” “attached,” “integrated,” or some combination thereof.

Unless explicitly defined herein, terms are to be construed in accordance with the plain and ordinary meaning as would be appreciated by one having skill in the art.

### GENERAL DESCRIPTION OF EMBODIMENTS

The film processing apparatus comprises a development tank system, a chemical system, a control system, and a power system. The development tank system is a sealable chamber in which film is processed. The chemical system stores development chemicals and conveys the development chemistry to the development tank system according to a selected routine. The control system stores a database of development routines which the user may select depending on the application. The control system then carries out the procedure associated with the user selected routine, maintaining variables like chemistry temperature and timing according to the selected routine. The power system supplies power to the various electrically powered components of the film processing apparatus.

### Development Tank System

The development tanks system comprises a development tank, an access opening, a cap, a chemistry port, a relief valve, a reel-column, a motor, and a magnetic coupling. The access opening is an opening in the development tank through which a user may access the internal components of the development tank and place or retrieve film reels. The user may reach through the access opening to place undeveloped film reels on the reel-column or to remove developed film reels from the reel-column. The cap is a removable covering for the access opening. The film holder is configured to hold multiple film reels. In some embodiments, the film holder is configured to hold five 135-format film reels. When in a closed position, the cap is coupled to the development tank, creating a liquid-tight, light-proof seal with the development tank. When in an open position, the cap is decoupled from the access opening such that a user may access the inside of the development tank.

The chemistry port is an opening into the development tank where development chemistry flows into and out of the development tank. The port is positioned at the bottom of the tank, and is used for filling and draining the tank.

The relief valve is an opening out of the development tank which allows air to enter or escape the development tank but prevents liquid from entering or escaping. While filling or draining the development tank, the air in the unfilled section of the tank becomes either pressurized or depressurized, inhibiting the further insertion or removal of chemistry. To prevent this, a valve on the upper section of the development tank allows ventilation into the tank and prevents the aforementioned pressure differential.

The motor may be attached or coupled to the exterior of the development tank. Inside the development there is a magnetic coupling which is attached or coupled to the interior of the tank. The magnetic coupling is free to rotate. The magnetic coupling is magnetically coupled to the motor. The motor exerts a torque on the magnetic coupling so as to impart a rotational magnetic force on a corresponding magnetic coupling. The reel-holder may be attached or coupled to the rotating portion of the magnetic coupling such that when the magnetic coupling rotates the reel-holder rotates with it. By rotating the film holder within the development tank, the development chemicals are agitated and brought into relative uniform contact with the film being developed. Proper agitation helps ensure a consistent and accurate development of the film.

In some embodiments, the development tank is a cylindrically shaped ABS plastic pipe. In some embodiments, the development tank is between 4-inches to 8-inches in diameter and between 8-inches and 16-inches in length.

### Chemical System

The chemical system comprises a plurality of chemical reservoirs, a plurality of chemical pumps, and a plurality of chemical conduits. The chemical reservoirs are configured to hold development chemistry. Chemical conduits are passageways through which development chemistry can be conveyed. Chemical conduits may connect the plurality of chemical reservoirs to the plurality of chemical pumps. Similarly, chemical conduits may connect the plurality of pumps to the development tank.

In some embodiments, the chemical system may further comprise a waste pump and a waste reservoir. Chemical conduits may connect the development tank with the waste pump and the waste pump with the waste reservoir such that used development chemicals may be pumped out of development tank into the waste reservoir. In some embodiments having a waste pump, the user may select a single reservoir to act as a waste reservoir while setting a given routine.

In some embodiments, the chemical system further comprises a quick-release connector located between the pump system and the development tank. The quick-release connector may be attached to chemical conduit upstream of the development tank and downstream of the chemical pump or pumps. The quick-release connector enables the user to separate the chemical system from the development system by creating a dry-break between them.

In some embodiments, there are fewer chemical pumps than chemical reservoirs. For example, and without limitation, a single chemical pump may be used to convey development chemicals from the chemical reservoirs to the development tank. In some embodiments having a single chemical pump, each chemical conduit leading away from each chemical reservoir may be adapted with a chemical valve. Downstream of the chemical valves the chemical conduits may merge using a manifold before passing through the chemical pump. When the development routine selects a development chemical to be introduced into the development tank, the chemical valve downstream of that selected chemical reservoir may open, thereby creating a pathway between the selected chemical reservoir and the development tank. When the chemical pump turns on development chemicals are drawn out of the selected chemical reservoir, pass through the opened chemical valve, through the chemical pump and into the development reservoir. In some embodiments, the chemical valves are “normally-closed” solenoid valves such that chemistry may only be drawn from a reservoir with a corresponding chemical valve which is receiving power.

In some embodiments, the film development apparatus may have six chemical valves. One chemical valve may be positioned on each of the five chemical conduits leading away from the chemical reservoirs, and one chemical valve may be disposed on the chemical conduit leading to the waste reservoir.

### Control System

The control system comprises wiring, a computer system, a plurality of heaters, a plurality of temperature sensors, a user interface, and a data port. The controls system is configured to control the motor, the plurality of heaters, the plurality of chemical pumps, and the plurality of temperature sensors. The wiring conductively connects various electrical components of the film processing apparatus comprising the computer system, the plurality of heaters, the plurality of pumps, and the plurality of temperature sensors, and the user interface.

The plurality of heaters are configured to impart heat energy to the development chemicals in the chemical reservoirs. In some embodiments, each chemical reservoir is adapted with a heater. For example, and without limitation, a film processing apparatus with five chemical reservoirs may have five heaters. In some embodiments, there are fewer heaters than chemical reservoirs. In such embodiments some or all of the heaters may be movable heaters. A movable heater may be configured to be moved by the user between two or more chemical reservoirs such that the movable heater may impart heat energy to selected chemical reservoirs. In some embodiments, the heaters and/or movable heaters may be immersion heaters. The heating element of an immersion heater partly or wholly submerged in the development chemicals held in a chemical reservoir.

The plurality of temperature sensors are configured to measure the temperature of the development chemicals held in the development reservoirs. In some embodiments, each chemical reservoir is adapted with a temperature sensor. For example, and without limitation, a film processing apparatus with five chemical reservoirs may have five temperature sensors. In preferred embodiments, each reservoir equipped with a heater is equipped with a corresponding temperature sensor.

The user interface comprises any means by which the user may receive information from the control system or interact with the control system. The user interface is configured to receive input commands from the user and transmit them to the computer system. The user interface is configured to receive output information from the control system and provide the output information to the user.

In some embodiments, the user interface may have display screens, d-pads, buzzers, dials, sliders, switches, buttons, a power switch, an emergency stop, a data port, or some combination thereof. The user interface may provide the user with various output information. For example and without limitation, the user interface may show a plurality of live temperature values of the development chemicals stored in the plurality of chemical reservoirs, a machine state, a process step run time, a total run time, a remaining run time, a list of selectable routines, an indication of the selected routine, or some combination thereof.

In some embodiments, the computer system comprises a raspberry pi. In some embodiments, the computer system further comprises a pump hub board, a heater hub board or some combination thereof. The heater hub board may be comprised of an Arduino that uses temperature sensor inputs and control over heater activation to achieve target temperatures communicated to the hub board by the central computer. The Arduino may achieve and maintain these temperatures precisely through software employing a proportional-integral-derivative control loop. Additionally, the heater hub board may communicate live temperature readings to the central computer and notifies it when target temperatures are achieved.

When actuated, the emergency-stop cuts power to the film processing apparatus. The user may wish to engage the emergency stop in the event of a system malfunction or operator error. The emergency stop adds a layer of safety to operating the film processing machine.

The computer system may store a plurality of development routines. A development routine is a set of control settings including, but not limited to, a set of selected development chemicals, a sequence of development chemicals, a timing of the development chemicals, and a temperature of the development chemicals introduced to the development reservoir. In some embodiments, the computer system may be configured to receive custom development routines. These custom development routines may be entered into the computer system in a variety of ways. In some embodiments, custom development routines may be manually entered by the user through the user interface. In some embodiments, the user may modify an existing development routine to suit their needs. In some embodiments, the user may upload one or more development routines through the data port.

### Power System

The power system receives electrical power and distributes it to the other electrical components of the film processing apparatus. The power system comprises a power cable a power supply. The power supply converts electrical power from a wall outlet into the correct voltage and current for the various components of the film processing apparatus.

### First Illustrated Embodiment

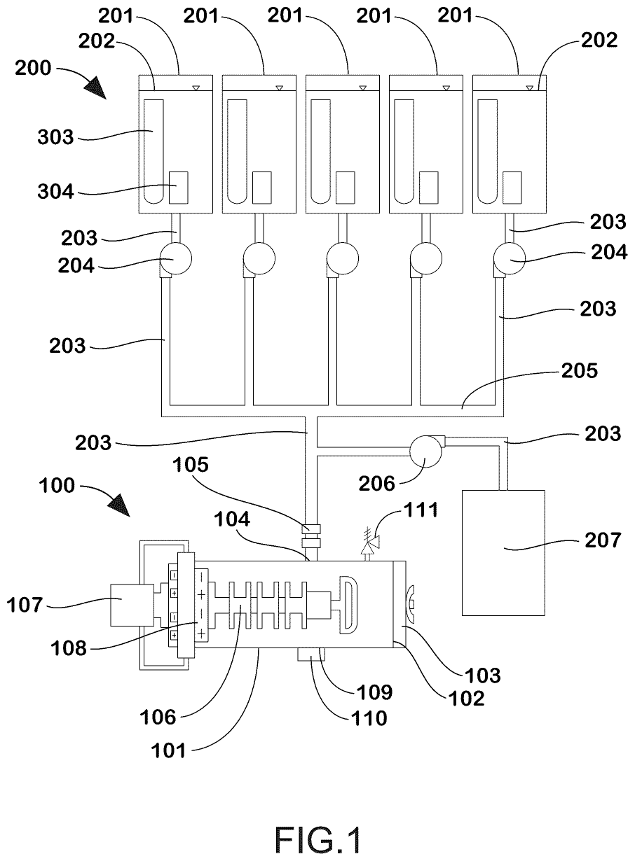

Now turning to the drawings, FIG. 1 shows a process flow diagram for a first illustrated embodiment of the film processing apparatus. The chemical system (200) comprises five chemical reservoirs (201) which hold development chemicals (202). The development chemicals are conveyed by chemical pumps (204) through chemical conduits (203) from their respective chemical reservoirs to the development tank (101). In this embodiment, the chemical conduits downstream of the chemical pumps merge together via a chemical manifold (205) upstream of the development tank. The development chemicals enter the development tank through the chemical port (104). The waste pump (206) conveys used development chemicals out of the development tank to the waste reservoir (207). There is a quick-release connector (105) on the chemical conduit entering the development tank.

The development tank system (100) comprises a development tank (101) having an access opening (102) which is covered by an openable cap (103). There is a relief valve (111) disposed on the development tank. The relief valve is configured to open if the pressure within the development tank exceeds a max pressure set point. The relief valve is also configured to open if the pressure within the development tank goes below a minimum pressure set point. A motor (107) is attached to the development tank. The motor magnetically spins a magnetic coupling (108) within the development tank. A film holder (106) is attached to the magnetic coupling such that when the magnetic coupling spins the film holder spins with it. The development tank has a drain (109) disposed near the bottom of the development tank. The drain is sealed with a removable plug (110).

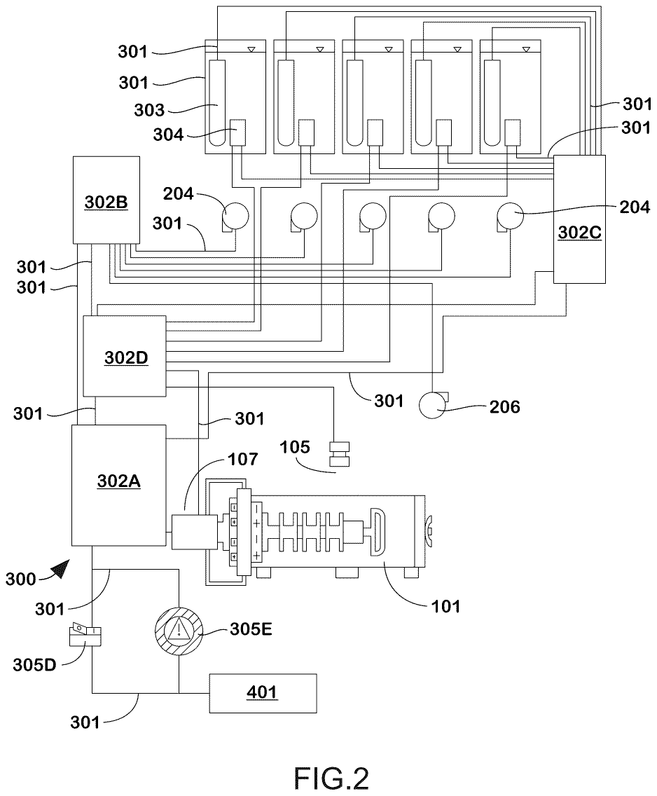

FIG. 2 shows the electrical components and the control system (300) for a first illustrated embodiment of the film processing apparatus. Various articles of wiring (301) connect the electrical components to the control system. The computer system (302) comprises a Raspberry Pi (302A), a pump hub board (302B), a heater hub board (302C), and a temperature hub board (303D). The Raspberry Pi is connected to the pump hub board, the heater hub board, and the temperature hub board. The Raspberry Pi controls and receives information from the three hub boards. The pump hub board is connected to the chemical pumps (204) and the waste pump (206). The heater hub board is connected to the heaters (303). The temperature hub board is connected to the temperature sensors (304). The Raspberry Pi is also connected to, and controls, the motor (107) and the quick-release connector (105). The film processing apparatus receives power from a power source (401).

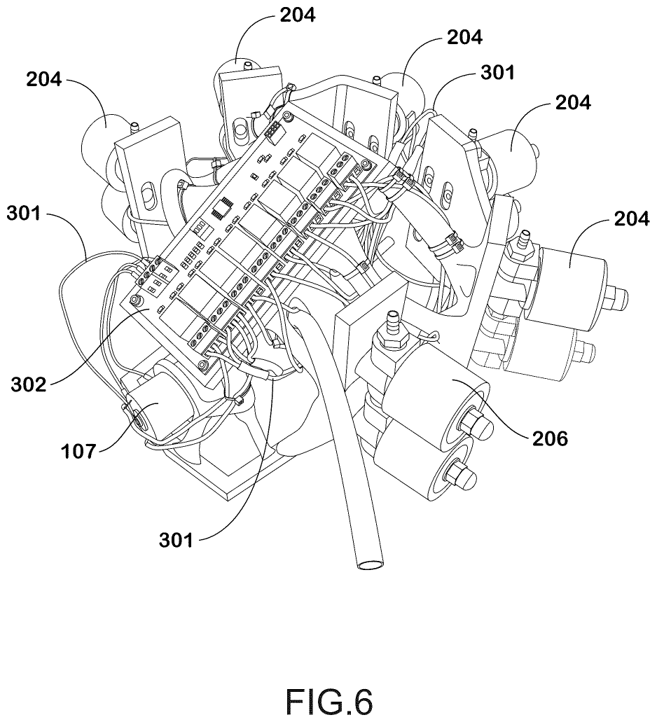

FIG. 6 shows an isometric view of part of the film processing apparatus. The five chemical pumps (204) and single waste pump (206) are shown. The pumps are connected to the computer system (300) by an assortment of wiring (301). The motor is shown mounted below the control system (300) in this embodiment.

### Second Illustrated Embodiment

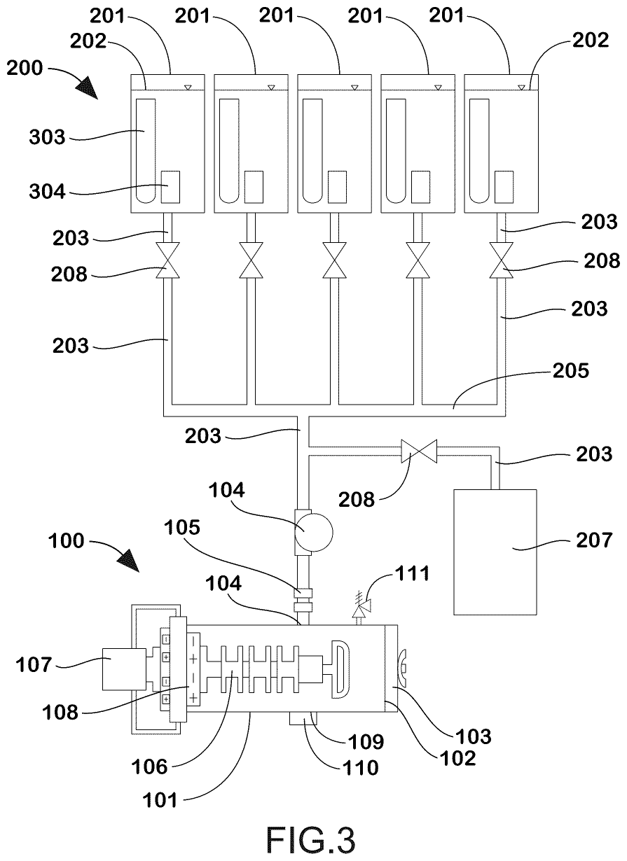

Now turning to the drawings, FIG. 3 shows a process flow diagram for a second illustrated embodiment of the film processing apparatus. Similar to the first illustrated embodiment, the chemical system (200) of the second illustrated embodiment comprises five chemical reservoirs (201) which hold development chemicals (202). The development chemicals are conveyed by a chemical pump (204) through chemical conduits (203) from their respective chemical reservoirs to the development tank (101). Each chemical conduit downstream of a chemical reservoir has a chemical valve (208). The chemical conduits downstream of the five chemical valves merge together via a chemical manifold (205) upstream of the development tank. The development chemicals enter the development tank through the chemical port (104). The chemical pump (204) in the second illustrated embodiment is bi-directional and also serves as the waste pump (206). The chemical pump is configured to convey used development chemicals out of the development tank to the waste reservoir (207). There is a quick-release connector (105) on the chemical conduit entering the development tank.

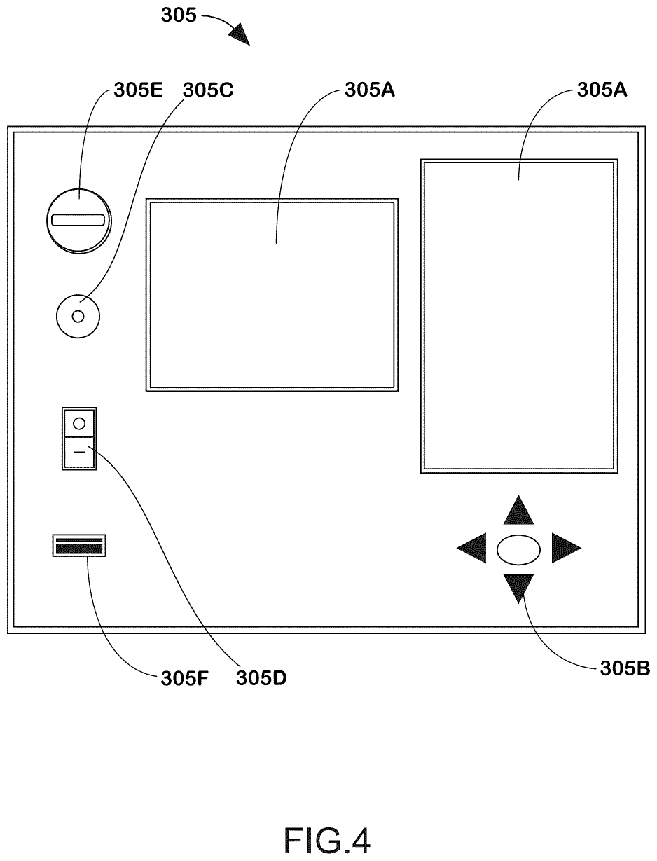

FIG. 4 shows the user interface (305) which may be used for the first or second illustrated embodiments of the film processing apparatus. The user interface is adapted with two display screens (302A) which are configured to display system information to the user, including but not limited to temperature set points, temperature values, machine states, selectable routines, and a selected routine. In this embodiment of the user interface, the user may navigate the display screens with a D-pad (305B). The user interface is also configured with a buzzer to audibly signal the user of a variety of useful machine states. For example and without limitation, the buzzer may buzz when the selected routine is complete. The user interface is further configured with a power switch (305D) and the emergency stop (305E) such that the user may start and stop the film processing apparatus. The user interface is configured with a data port (305F), which in this embodiment is a USB drive port. The user may upload or download a variety of digital information though this data port. For example and without limitation the user may upload customized selectable routines via the data port.

### Third Illustrated Embodiment

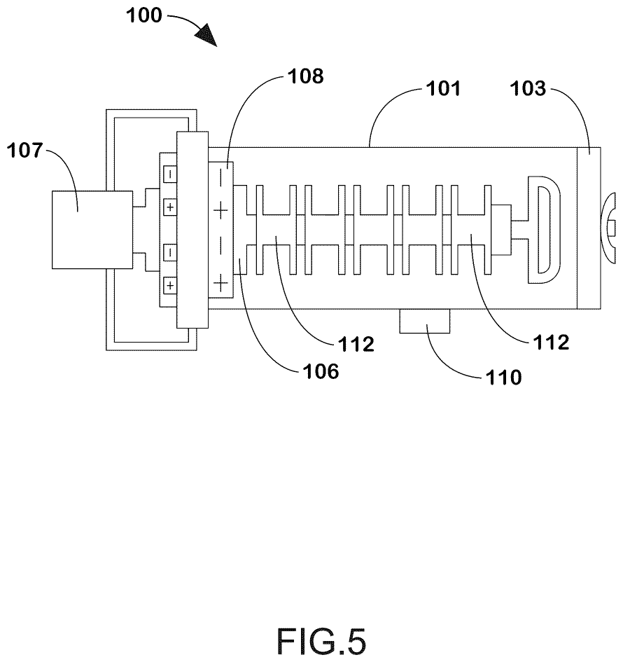

FIG. 5 shows a development tank system (100) in accordance with a third illustrated embodiment. This film holder (106) has room for five film reels (112).

Feature List

| | |
|---|---|
| Development Tank System | (100) |
| Development Tank | (101) |
| Access Opening | (102) |
| Cap | (103) |
| Chemical Port | (104) |
| Quick-Release Connector | (105) |
| Film Holder | (106) |
| Motor | (107) |
| Magnetic Coupling | (108) |
| Drain | (109) |
| Plug | (110) |
| Pressure Relief Valve | (111) |
| Film Reel | (112) |
| Chemical System | (200) |
| Chemical Reservoir | (201) |
| Development Chemicals | (202) |
| Chemical Conduit | (203) |
| Chemical Pump | (204) |
| Chemical Manifold | (205) |
| Waste Pump | (206) |
| Waste Reservoir | (207) |
| Chemical Valve | (208) |
| Control System | (300) |
| Wiring | (301) |
| Computer system | (302) |
| Raspberry Pi | (302A) |
| Pump Hub Board | (302B) |
| Heater Hub Board | (302C) |
| Temperature Hub Board | (302D) |
| Heater | (303) |
| Temperature Sensor | (304) |
| User Interface | (305) |
| Display Screen | (305A) |
| Temperature Set Points | |
| Temperature Values | |
| Machine States | |
| Selectable Routines | |
| Selected Routine | |
| D-Pad | (305B) |
| Buzzer | (305C) |
| Power Switch | (305D) |
| Emergency Stop | (305E) |
| Data Port (e.g. USB) | (305F) |
| Power System | |
| Power Source | (401) |

Embodiment 1: Most general claim

What is claimed is:

1. A film processing apparatus, comprising:
a. A development tank system; the development tank system comprising a development tank, an access opening, a cap, a chemical port, a relief valve, a reel column, a motor, and a magnetic coupling, the cap configured to cover the opening when coupled to the development tank in a closed position, the chemical port being an opening through the development tank through which development chemicals may pass, the relief valve configured to mitigate against the development of pressure differentials within the development tank, the motor being attached to the exterior of the development tank, the magnetic coupling mounted to the interior of the development tank, the motor configured to impart a rotational force to the magnetic coupling, the reel column configured to hold the film to be developed, the reel column attached to the magnetic coupling such that when the magnetic coupling rotates, the reel column rotates with it;
b. A chemical system; the chemical system comprising a plurality of chemical reservoirs, a plurality of chemical pumps, and plurality of chemical conduits, the plurality of chemical reservoirs configured to hold development chemicals, the plurality of chemical pumps configured to convey development chemicals from the chemical reservoirs to the development tank, the chemical conduits being liquid passageways connected between components of the film processing apparatus comprising the plurality of chemical reservoirs, the plurality of chemical pumps, and the development tank;
c. A control system; the control system comprising wiring, a computer system, a plurality of heaters, a plurality of temperature sensors, a user interface, and a data port, the computer system configured to control the motor, the plurality of heaters, the plurality of chemical pumps, and the plurality of temperature sensors, the wiring conductively connecting components of the film processing apparatus comprising the computer system, the plurality of heaters, the plurality of chemical pumps, the plurality of temperature sensors, the user interface, the plurality of heaters configured to impart heat energy to the development chemicals in the chemical reservoirs, the temperature sensors configured to measure the temperature of the development chemicals in the chemical reservoirs, the user interface configured to receive input commands from the user and transmit those input commands to the computer system, the user interface configured to receive output information from the control system and provide the output information to the user;
d. A power system; the power system comprising a power cable which conveys power from a power source to the film processing apparatus.
Quick-release connector

2. The film processing apparatus of claim 1, further comprising:
a. A quick-release connector, the quick-release connector disposed between the plurality of chemical pumps and the development tank, the quick-release connector configured to be decoupled thereby creating an air gap between the plurality of chemical pumps and the development tank.
Waste pump

3. The film processing apparatus of claim 1, further comprising:
a. A waste pump, the waste pump connected to chemical conduit which is connected to the development tank, the waste pump configured to draw development chemicals out of the development tank.
Waste reservoir

4. The film processing apparatus of claim 3, further comprising:
a. A waste reservoir, the waste reservoir connected to chemical conduit which is connected to the waste pump, the waste reservoir configured to receive development chemicals which are drawn out of the development tank by the waste pump.
Raspberry Pi

5. The film processing apparatus of claim 1, wherein:
a. The computer system comprises a raspberry pi.
Pump, Heater, Temperature Hub Boards

6. The film processing apparatus of claim 5, wherein:
a. The computer system further comprises a pump hub board, a heater hub board, and a temperature hub board, the pump hub board communicating information between the computer system and the plurality of chemical pumps in order to control the plurality of chemical pumps, the heater hub board communicating information between the computer system and the plurality of heaters in order to control the plurality of heaters, the temperature hub board communicating information between the computer system and the plurality of temperature sensors in order to control the plurality of temperature sensors.
Display screen(s)

7. The film processing apparatus of claim 1, wherein:
a. The user interface comprises a display screen, the display screen configured to provide output information comprising:
i. A plurality of temperature set points of the development chemicals stored in the plurality of chemical reservoirs,
ii. A plurality of live temperature values of the development chemicals stored in the plurality of chemical reservoirs,
iii. A machine state
iv. A plurality of selectable Routines
v. A plurality of selected Routines
Emergency stop

8. The film processing apparatus of claim 1, further comprising:
a. An emergency stop, the emergency stop being a device which, when activated, stops electrical power from the power source to the film processing apparatus.
Five chemical pumps

9. The film processing apparatus of claim 1, wherein:
a. There are five chemical reservoirs and five chemical pumps, each chemical pump is paired with one chemical reservoir, each chemical pump configured to convey development chemicals from chemical reservoir the chemical pump is paired with to the development tank.
Five heaters, five temp sensors

10. The film processing apparatus of claim 9, wherein:
a. There are five heaters, and five temperature sensors, each heater is paired with one chemical reservoir, each heater configured to transfer heat energy into the development chemicals held in the chemical reservoir to which it is paired, each heater controlled by the control system,
b. There five temperature sensors, each temperature sensor is paired with one chemical reservoir, each temperature sensor configured to determine the temperature of the development chemicals held in the chemical reservoir to which it is paired.
Computer stores development routines

11. The film processing apparatus of claim 1, wherein:
a. The computer system stores a plurality of development routines, each development routine being a set of control settings comprising the selected development chemicals, the sequence of the development chemicals, timing of the development chemicals, and the temperature of the development chemicals introduced to the development reservoir.
Custom development routines

12. The film processing apparatus of claim 1, wherein:
a. The computer system is configured to receive custom development routines entered by a user.
Embodiment 2: Three movable heaters

13. A film processing apparatus, comprising:
a. A development tank system; the development tank system comprising a development tank, an access opening, a cap, a chemical port, a film holder, a motor, and a magnetic coupling, the cap configured to cover the opening when coupled to the development tank in a closed position, the chemical port being an opening through the development tank through which development chemicals may pass, the motor being attached to the exterior of the development tank, the magnetic coupling mounted to the interior of the development tank, the motor configured to impart a rotational force to the magnetic coupling, the film holder configured to hold the film to be developed, the film holder attached to the magnetic coupling such that when the magnetic coupling rotates, the film holder rotates with it;
b. A chemical system; the chemical system comprising a plurality of chemical reservoirs, a plurality of chemical pumps, and plurality of chemical conduits, the plurality of chemical reservoirs configured to hold development chemicals, the plurality of chemical pumps configured to convey development chemicals from the chemical reservoirs to the development tank, the chemical conduits being liquid passageways connected between components of the film processing apparatus comprising the plurality of chemical reservoirs, the plurality of chemical pumps, and the development tank;
c. A control system; the control system comprising wiring, a computer system, three movable heaters, a plurality of temperature sensors, a user interface, and a data port, the computer system configured to control the motor, the three movable heaters, the plurality of chemical pumps, and the plurality of temperature sensors, the wiring conductively connecting components of the film processing apparatus comprising the computer system, the three movable heaters, the plurality of chemical pumps, the plurality of temperature sensors, the user interface, the three movable heaters configured to impart heat energy to the development chemicals in the chemical reservoirs, the temperature sensors configured to measure the temperature of the development chemicals in the chemical reservoirs, the user interface configured to receive input commands from the user and transmit those input commands to the computer system, the user interface configured to receive output information from the control system and provide the output information to the user;
d. A power system; the power system comprising a power cable which conveys power from a power source to the film processing apparatus.
Embodiment 3: Single pump

14. A film processing apparatus, comprising:
a. A development tank system; the development tank system comprising a development tank, an access opening, a cap, a chemical port, a film holder, a motor, and a magnetic coupling, the cap configured to cover the opening when coupled to the development tank in a closed position, the chemical port being an opening through the development tank through which development chemicals may pass, the motor being attached to the exterior of the development tank, the magnetic coupling mounted to the interior of the development tank, the motor configured to impart a rotational force to the magnetic coupling, the film holder configured to hold the film to be developed, the film holder attached to the magnetic coupling such that when the magnetic coupling rotates, the film holder rotates with it;
b. A chemical system; the chemical system comprising a plurality of chemical reservoirs, a plurality of valves, a chemical pump, and plurality of chemical conduits, the plurality of chemical reservoirs configured to hold development chemicals, the plurality of valves configured to selectively open such that a pathway is created between a plurality of chemical reservoirs and the chemical pump, the chemical pump configured to convey development chemicals from the chemical reservoirs to the development tank, the chemical conduits being liquid passageways connected between components of the film processing apparatus comprising the plurality of chemical reservoirs, the chemical pump, and the development tank;
c. A control system; the control system comprising wiring, a computer system, a plurality of heaters, a plurality of temperature sensors, a user interface, and a data port, the computer system configured to control the motor, the plurality of heaters, the plurality of valves, the chemical pump, and the plurality of temperature sensors, the wiring conductively connecting components of the film processing apparatus comprising the computer system, the plurality of heaters, the plurality of valves, the chemical pump, the plurality of temperature sensors, the user interface, the plurality of heaters configured to impart heat energy to the development chemicals in the chemical reservoirs, the temperature sensors configured to measure the temperature of the development chemicals in the chemical reservoirs, the user interface configured to receive input commands from the user and transmit those input commands to the computer system, the user interface configured to receive output information from the control system and provide the output information to the user;
d. A power system; the power system comprising a power cable which conveys power from a power source to the film processing apparatus.

15. The film processing apparatus of claim 14, wherein:
a. There are six valves.

16. The film processing apparatus of claim 14, wherein:
a. The valves are normally-closed, solenoid-operated valves.
